(19) United States
(12) Patent Application Publication
(10) Pub. No.: US 2020/0126041 A1
(43) Pub. Date: Apr. 23, 2020

(54) COMPLAINTS MANAGEMENT SYSTEM AND METHOD THEREOF

(71) Applicant: Senthilkumar VELUSAMY SIVASAMY, Virginia Beach, VA (US)

(72) Inventor: Senthilkumar VELUSAMY SIVASAMY, Virginia Beach, VA (US)

(21) Appl. No.: 16/163,206

(22) Filed: Oct. 17, 2018

(51) Int. Cl. G06Q 10/10; G06Q 10/06; G06Q 30/00; H04L 29/08

(52) U.S. Cl. CPC G06Q 10/103; G06Q 10/063112; H04L 67/2809; H04L 67/12; G06Q 30/016

(57) ABSTRACT

A complaints management system (CMS) to manage complaints is disclosed. The system receives, in response to an input provided by a user on an Internet of Things (IoT) device, a first data packet pertaining to a complaint; generates a complaint ticket carrying at least a unique identifier associated with the complaint, allocates the complaint to an appropriate service person, determines a complaint confirmation information comprising various relevant details, transmits the complaint ticket to a second computing device of the service person and transmits the complaint confirmation information to the IoT device for display thereupon; and receives from the second computing device a complaint resolution information indicating resolution of the complaint and transmits the complaint resolution information to the IoT device for display thereupon.

### FIELD OF DISCLOSURE

The present disclosure relates to complaints management systems. In particular, it pertains to a complaints management system to manage various complaints pertaining to malfunctioning equipment.

### BACKGROUND

Residential complexes as well as similar multi-dwelling units such as hotels, hospitals and the like have a variety of equipment to provide various services to occupants/residents. Such services include plumbing, electricity, security, fire alarm, laundry and the like. Some such services also offer revenue generation opportunities. For instance, an apartment complex many times has a central laundry that uses coin operated machines. Residents operate/switch on various laundry machines such as washers and dryers by putting coins into them whereby such machines run for a pre-determined amount of time.

As is to be expected, various equipment in an apartment complex may face breakdowns and other operational problems. A lift may not work, a plumbing fixture may get choked up or develop a leak, an air-conditioner may stop working etc. Typically, the residents (users) of the apartment complex are provided a ‘complaints register’ which is a notebook in which they can enter their complaints. The register is looked into at intervals by a nominated person (usually a manager or a functionary from the Residents Welfare Society who then forwards the complaints to concerned personnel for necessary action. For instance, a plumbing complaint gets forwarded to a plumber while a lift non-functional complaint gets forwarded to a lift technician, and the like. As can be appreciated, this approach is highly inefficient as it may take hours and even days for a complaint even to be received by concerned personnel.

Another approach is based on allocation of a pre-designated phone number that the users are expected to call to record their complaints such that the complaints are then forwarded periodically to concerned personnel. Since there can be many complaints, this phone number is mostly busy. So even recording of complaints is a difficult exercise in such an approach. Thereafter, forwarding a complaint to right service person/technician is again an inefficient and time consuming process. Some other solutions are based on Interactive Voice Response (IVR) system where selecting right language and getting past the various menus to speak to a complaint handler may easily take 3-4 minutes, if not more. Moreover, even thereafter there is no assurance when the complaint will reach the concerned service personnel.

In some cases, this may lead to even monetary loss for the property owners. For instance, if a coin-operated laundry machine is not working, a user may simply opt to use another machine elsewhere rather than take the trouble to report the fault. In such a case, every day that the machine remains non-operational represents a loss for the property owner. The property owner may come to know of the non-operational machine only when it itself conducts a survey of the property and various equipment therein, which may be many days if not weeks later.

In various other similar situations, for instance highway restrooms or corporate office restrooms people may not show any interest to even lodge a complaint. Rather, their urgency may make them choose other functional alternatives readily available. As already elaborated, even when a complaint is lodged, when it reaches the concerned service personnel and is operated upon always remains uncertain. As can be readily understood from above, existing solutions are prone to high levels of user dissatisfaction and also, in many cases, revenue loss for property owners. Hence, there is a need in the art for a system that enable service complaints for various equipment to be lodged immediately, which can be transferred to concerned service personnel for timely resolution without any time loss.

### OBJECTS OF THE PRESENT DISCLOSURE

Some of the objects of the present disclosure, which at least one embodiment herein satisfies are as listed herein below.

It is an object of the present disclosure to provide for a complaints management system that enables an equipment maintenance complaint to be lodged immediately.

It is another object of the present disclosure to provide for a complaints management system that enables an equipment maintenance complaint to be transferred without any time loss from its initiation to concerned service personnel for timely resolution.

It is another object of the present disclosure to provide for a complaints management system that monitors an equipment maintenance complaint from its initiation to its resolution.

It is another object of the present disclosure to provide for a complaints management system that reduces downtime, improves productivity of machines and thereby reduces operational cost and increases profit, while at the same time increasing satisfaction of users.

### SUMMARY

This summary is provided to introduce simplified concepts of a complaints management system, which are further described below in the Detailed Description. This summary is not intended to identify key or essential features of the claimed subject matter, nor is it intended for use in determining/limiting the scope of the claimed subject matter.

The present disclosure mainly relates to a complaints management system to manage various complaints. The complaints can pertain to various malfunctioning equipment or service requests. In particular it pertains to a complaints management system wherein complaints are appropriately handled automatically without any delay.

In an aspect, present disclosure elaborates upon a complaints management system (CMS) that can be configured in a first computing device and can include: a data processing system comprising a memory storing processor-executable instructions; and one or more processors configured to execute the processor-executable instructions to: receive, in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets; generate, based upon the first data packet, a complaint ticket carrying at least a unique identifier associated with the complaint and allocate the complaint to an appropriate service person; determine a complaint confirmation information comprising any or a combination of description of the complaint, unique identifier of the complaint ticket, details of the service person assigned to the complaint and expected time of resolution of the complaint; transmit the complaint ticket to a second computing device of the service person and transmit the complaint confirmation information to the IoT device for display thereupon; and receive from the second computing device a complaint resolution information indicating resolution of the complaint or part thereof by the service person and transmit the complaint resolution information or part thereof to the IoT device for display thereupon.

In another aspect, the message queuing protocol can enable queuing of the plurality of data packets indicating corresponding complaints at any or a combination of one or more of the IoT devices and the first computing device.

In yet another aspect, the first data packet can be selected from the plurality of data packets based on any or a combination of an order in which the plurality of data packets are received at the first computing device and an order in which the plurality of data packets are generated at the one or more of the IoT devices.

In an aspect, the user can provide the input by pressing a push button on the IoT device such that a Light Emitting Diode (LED) can be switched on, and the LED can be switched off upon receipt of complaint resolution information.

In another aspect, the first computing device can be configured at a cloud.

In yet another aspect, the system can store data pertaining to any or a combination of complaint, complaint ticket, complaint confirmation information and complaint resolution information in a database for analysis as needed.

In an aspect, the IoT device can use regular electric supply, and can automatically switch to an alternate power supply during any disruption in the regular electric supply.

In another aspect, the first computing device can communicate with the IoT device and the second computing device using any or a combination of Internet, Global System for Mobile Communication (GSM), Wi-Fi, Local Area Network (LAN), Wide Area Network (WAN), Zigbee and Bluetooth.

In yet another aspect, the data packets, the complaint ticket, the complaint confirmation information and the complaint resolution information can be communicated in form of any or a combination of SMS, email audio and video.

In an aspect, present disclosure elaborates upon a method for complaints management, the method including: receiving, at a first computing device in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets; generating, at the first computing device, based upon the first data packet, a complaint ticket carrying at least a unique identifier associated with the complaint and allocate the complaint to an appropriate service person; determining, at the first computing device, a complaint confirmation information comprising any or a combination of description of the complaint, unique identifier of the complaint ticket, details of the service person assigned to the complaint and expected time of resolution of the complaint; transmitting, using the first computing device, the complaint ticket to a second computing device of the service person and transmitting, using the first computing device, the complaint confirmation information to the IoT device for display thereupon; and receiving, at the first computing device from the second computing device, a complaint resolution information indicating resolution of the complaint or part thereof by the service person and transmitting, using the first computing device, the complaint resolution information or part thereof to the IoT device for display thereupon.

The technical problem solved by the proposed system is elimination of delays in passing complaints to concerned personnel that occur in present paper based or telephonic systems. Proposed system solves this technical problem by receiving from an Internet of Things (IoT) device data packets pertaining to various complaints, passing the complaints immediately to various service personnel, and keeping track of the complaints till their resolution.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates overall architecture of the proposed system, in accordance with an exemplary embodiment of the present disclosure.

FIG. 2 illustrates functional units of system proposed in accordance with an exemplary embodiment of the present disclosure.

FIGS. 3A to 3E illustrate working of the proposed system in accordance with an exemplary embodiment of the present disclosure.

FIG. 4 illustrates a method of working of system proposed in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). A machine-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

In various implementations, computing devices used herein may be any of a variety of types of computing device, including without limitation, a desktop computer system, a data entry terminal, a laptop computer, a notebook computer, a tablet computer, a handheld personal data assistant, a smartphone, a body-worn computing device incorporated into clothing, a computing device integrated into a vehicle (e.g., a car, a bicycle, etc.), a server, a cluster of servers, a server farm, etc.

In another aspect, relevant units of the proposed system can be configured to be operatively connected to a website, or be part of a mobile application that can be downloaded on a mobile device that can connect to Internet. In such fashion the proposed system can be available 24*7 to its users. Any other manner of implementation of the proposed system or a part thereof is well within the scope of the present disclosure/invention.

It would be appreciated that units/components of proposed system elaborated herein are only exemplary units and any other unit or sub-unit can be included as part of the proposed system. These units too can be merged or divided into super-units or sub-units as may be configured.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

The present disclosure mainly relates to a complaints management system to manage various complaints. The complaints can pertain to various malfunctioning equipment or service requests. In particular it pertains to a complaints management system wherein complaints are appropriately handled automatically without any delay.

In an aspect, present disclosure elaborates upon a complaints management system (CMS) that can be configured in a first computing device and can include: a data processing system comprising a memory storing processor-executable instructions; and one or more processors configured to execute the processor-executable instructions to: receive, in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets; generate, based upon the first data packet, a complaint ticket carrying at least a unique identifier associated with the complaint and allocate the complaint to an appropriate service person; determine a complaint confirmation information comprising any or a combination of description of the complaint, unique identifier of the complaint ticket, details of the service person assigned to the complaint and expected time of resolution of the complaint; transmit the complaint ticket to a second computing device of the service person and transmit the complaint confirmation information to the IoT device for display thereupon; and receive from the second computing device a complaint resolution information indicating resolution of the complaint or part thereof by the service person and transmit the complaint resolution information or part thereof to the IoT device for display thereupon.

In another aspect, the message queuing protocol can enable queuing of the plurality of data packets indicating corresponding complaints at any or a combination of one or more of the IoT devices and the first computing device

In yet another aspect, the first data packet can be selected from the plurality of data packets based on any or a combination of an order in which the plurality of data packets are received at the first computing device and an order in which the plurality of data packets are generated at the one or more of the IoT devices.

In an aspect, the user can provide the input by pressing a push button on the IoT device such that a Light Emitting Diode (LED) can be switched on, and the LED can be switched off upon receipt of complaint resolution information.

In another aspect, the first computing device can be configured at a cloud.

In yet another aspect, the system can store data pertaining to any or a combination of complaint, complaint ticket, complaint confirmation information and complaint resolution information in a database for analysis as needed.

In an aspect, the IoT device can use regular electric supply, and can automatically switch to an alternate power supply during any disruption in the regular electric supply.

In another aspect, the first computing device can communicate with the IoT device and the second computing device using any or a combination of Internet, Global System for Mobile Communication (GSM), Wi-Fi, Local Area Network (LAN), Wide Area Network (WAN), Zigbee and Bluetooth.

In yet another aspect, the data packets, the complaint ticket, the complaint confirmation information and the complaint resolution information can be communicated in form of any or a combination of SMS, email, audio and video.

In an aspect, at least a part of the system is configured in or operatively coupled to a digital assistant device that receives the first data packet.

In an aspect, present disclosure elaborates upon a method for complaints management, the method including: receiving, at a first computing device in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets; generating, at the first computing device, based upon the first data packet, a complaint ticket carrying at least a unique identifier associated with the complaint and allocate the complaint to an appropriate service person; determining, at the first computing device, a complaint confirmation information comprising any or a combination of description of the complaint, unique identifier of the complaint ticket, details of the service person assigned to the complaint and expected time of resolution of the complaint; transmitting, using the first computing device, the complaint ticket to a second computing device of the service person and transmitting, using the first computing device, the complaint confirmation information to the IoT device for display thereupon; and receiving, at the first computing device from the second computing device, a complaint resolution information indicating resolution of the complaint or part thereof by the service person and transmitting, using the first computing device, the complaint resolution information or part thereof to the IoT device for display thereupon.

Various objects, features, aspects and advantages of the present disclosure will become more apparent from the following detailed description of preferred embodiments, along with the accompanying drawing figures in which like numerals represent like features.

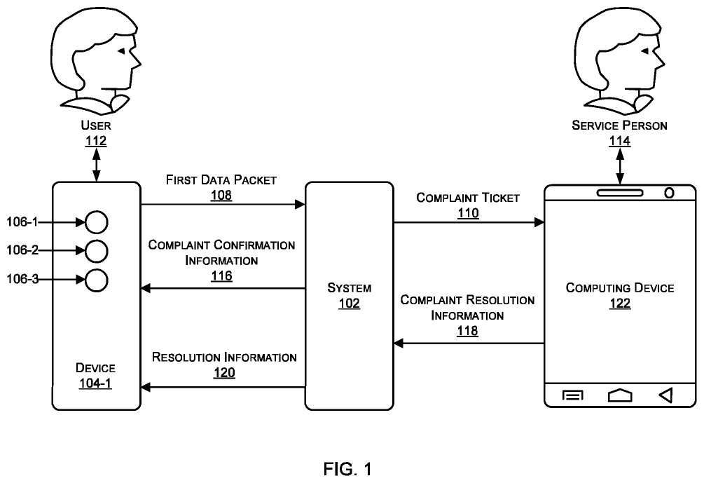

FIG. 1 illustrates overall architecture of the proposed system in accordance with an exemplary embodiment of the present disclosure.

In an aspect, proposed system 102 can include a plurality of IoT (Internet of Things) devices such as device 104-1 illustrated, collectively termed as IoT devices 104. Each of the IoT devices can have means to enable a user (such as user 112 shown) provide one or more inputs pertaining to complaints that the user wants to lodge. Such input means can include, for example, a microphone to receive voice messages, keypad to input text, writing on a touch sensitive screen, pushbuttons or any combination of these or any more means.

In an exemplary embodiment described herein, each device 104 can have a plurality of pushbuttons (interchangeably termed herein as button or buttons herein) collectively termed as 106 for a user to provide such inputs. Pushing a pushbutton 106-1 on IoT device 104-1 can generate a data packet shown as first data packet 108 that can pertain to a complaint that the user 112 wants to lodge or a service required by the user 112. It can be readily appreciated that service required can as well pertain to a complaint and the two terms are used interchangeably herein. Different pushbuttons can be pressed to lodge different complaints.

In another aspect, proposed system 102 can use a message queuing protocol wherein the message queuing protocol can maintain a queue of plurality of data packets being generated from one/more of IoT devices 104 such that the first data packet can be selected from the plurality of data packets.

In yet another aspect, first data packet 108 can be transmitted over a communication network and received by relevant components of system 102 that can be, for instance, configured in a first computing device/cloud. Upon such receipt, system 102 can determine from first data packet 108 service person (service person 114) that can provide service required (or resolve complaint lodged) and generate a complaint ticket 110 accordingly. Complaint ticket 110 can carry at least a unique identifier associated with the complaint (that the user 112 has lodged) and can be allocated to an appropriate service person.

In an aspect, proposed system 102 can determine complaint confirmation information 116. The complaint confirmation information 116 can include any or a combination of description of said complaint, unique identifier of said complaint ticket, details of said service person assigned to the complaint and expected time of resolution of said complaint.

In another aspect, system 102 can transmit complaint ticket 110 to a second computing device (computing device 122) of service person 114 for necessary action by service person 114, and can transmit complaint confirmation information 116 to IoT device 104-1 for display thereupon.

In yet another aspect, proposed system 102 can receive from computing device 122 a complaint resolution information 118 indicating resolution of the complaint or part thereof by the service person 114. Further, proposed system 102 can transmit complaint resolution information 118 or part thereof to IoT device 104-1 for display thereupon, as illustrated by resolution information 120. Complaint resolution information 118 can be based upon inputs provided by service person 114 and can include various data, for instance ‘will come in 15 minutes’, ‘on the way’ etc. that can as well be included in resolution information 120.

In another aspect, the message queuing protocol can enable queuing of the plurality of data packets indicating corresponding complaints at any or a combination of one or more of the IoT devices 104 and the first computing device where the proposed system is configured.

Such queuing can happen due various reasons. For instance, there can be a delay in communication between the first computing device and one or more of IoT devices 104. Or the first computing device can receive a plurality of data packets from the one or more of IoT devices 104. The message queuing protocol can enable queuing of messages at the IoT devices as well as the proposed system. For instance, IoT device 104-1 can store various messages (data packets) when there is no communication between itself and the first computing device, and can transmit all such stored messages when communication resumes.

In yet another aspect, the data packet 108 can be selected from the plurality of data packets based on any or a combination of an order in which the plurality of data packets are received at the first computing device and an order in which the plurality of data packets are generated at the one or more of the IoT devices 104. For instance, one data packet 108a from IoT device 104-1 can be received at 11:10 AM, while another data packet 108b from IoT device 104-2 can be received at 11:12 AM. Data packet 108a can be handled first. In this manner, various complaints can be handled in the order they are received at the proposed system/first computing device.

In an exemplary embodiment being described herein, the user can provide the input (pertaining to a complaint) by pressing push button 106-1 on IoT device 104-1. Upon such pressing, an LED can light up (the LED can be configured with pushbutton 106-1 itself). Upon receipt of complaint resolution information (resolution information 120) by the IoT device 104-1 the LED can be switched off.

In an aspect, the first computing device where proposed system 102 is configured can be configured at a cloud.

In another aspect, system 102 can store all information such as data pertaining to any or a combination of the complaint, complaint ticket 110, complaint confirmation information 116 and complaint resolution information 118 in a database for analysis as needed. As can be appreciated, as data from different IoT devices 104 pertaining to different equipment, services, complaints etc. accumulates in the database, it can be used for various purposes. For example, performance of different equipment as well as service persons can be readily evaluated.

IoT devices 104 can use regular electric supply, and can automatically switch to an alternate power supply due to disruption therein. For instance, device 104 can switch to a rechargeable battery or a solar panel during any disruption in regular electric supply due any emergency such as a storm etc.

The first computing device can communicate with IoT devices 104 and second computing device (computing device 122) using any or a combination of Internet, Global System for Mobile Communication (GSM), Wi-Fi, Local Area Network (LAN), Wide Area Network (WAN), Zigbee and Bluetooth.

Data packet 108, complaint ticket 110, complaint confirmation information 116 and complaint resolution information 118 can be communicated in form of any or a combination of SMS, email, audio and video.

Each pushbutton 106 on a device 104 can be associated with a service required/complaint to be lodged and such association indicated on the panel/buttons using appropriate means such as labels, numbers, colors etc. For instance, a laundry machine can be catered using an IoT device with three pushbuttons configured to provide the corresponding data packets, each button carrying a different color for a different service/complaint such as machine not working, no detergent and no water supply. Similarly, a restroom can have five differently colored buttons to provide appropriate date packets associated with different services. An apartment complex can use an IoT device 104 with pushbuttons 106 associated with different services such as Air-conditioning, Plumbing, Electric Supply, Laundry Collection etc. and may be labelled accordingly. Pushing a pushbutton 106 can raise a service request/complaint pertaining to the service labelled upon the button.

As can be readily appreciated, using such buttons, a customer/user can provide necessary signals to proposed system per service required by him/her without any intermediary and associated shortcomings such as waiting time, inaccurate understanding of the service required/complaint etc. Delays in forwarding complaint to relevant service personnel can as well be avoided.

As known, IoT devices 104 can be configured using existing platforms such as Raspberry pi, with their software built using languages such as C++, python and java. However; this is only exemplary and not to be construed as a limitation. The devices can have an external antenna to boost signals generated. Signals generated can use any appropriate protocol such as GSM or Wi-Fi.

In an aspect, an IoT device 104 can be configured with a light to indicate it is operational. Lights can as well be configured within pushbuttons associated with an IoT device 104 as already described. In this manner, the status (operational/non-operational) of an IoT device 104 or that of different service requests/complaints lodged using it can be readily ascertained just by a glance at any time.

In an exemplary embodiment, when a button (for instance button 106-1) of the IoT device 104-1 is pushed, the device can boot up, connect to network used by proposed system and thereafter send a data packet 108 (such as first data packet 108) to relevant units of the proposed system that can be configured in a server/first computing device (that can be configured in the cloud) via an appropriate message protocol for storage into a database that can be part of system 102 or operatively connected to it. The database can be used to store the first data packet 108, as well as other information generated by the proposed system, and can include any database like MYSQL, Oracle DB, DB2, Maria DB, Postgresql, cloud sql etc. A data analysis engine in proposed system 102 can enable its administrator to analyze all such information to generate useful reports such as maintenance history of various machines, performance of various service persons etc. etc. As can be readily understood, all such information can be very useful.

First data packet 108 can be received by proposed system 102 using any appropriate message protocol such as, but not limited to Data Distribution Service DDS, Constrained Application Protocol CoAP, Message Queuing Telemetry Transport MQTT, Advanced Message Queuing Protocol AMQP, Java Message Service JMS, eXtensible Messaging and Presence Protocol XMPP and Representational State Transfer REST.

As can be readily understood, manager/administrator of the proposed system can write own service and maintenance software or integrate the data being generated by proposed system into their existing systems.

In an aspect, devices 104 can communicate with system 102 using any or a combination of GSM and Wi-Fi. System 102 can enable shift from one communication mode to another as required. For instance, when there is a Wi-Fi outage/disruption due any reason (for instance a fire), proposed system can communicate devices 104 using GSM.

As already said, devices 104 can be so configured as to generate data packets for each of the buttons (collectively termed herein as 106). Each button can be associated with a complaint/purpose/service request (that can be labelled on the button or written next to it) and can be pressed by a user to generate corresponding data packet. Hence, as can be readily understood, a data packet can carry information pertaining to the complaint/purpose/service that needs addressing. In an exemplary embodiment, there can be ten different buttons to cater to ten different complaints etc.

Devices 104 can have a small screen that can display complaint confirmation information 116 as well as complaint resolution information (as resolution information 120) where it can be seen by corresponding users (such as user 112 for device 104-1). In alternate exemplary configurations the screen can comprise a graphic display such as LCD/LED/OLED and can display pertinent information for users of IoT devices 104. The screen/graphic display can as well be operatively connected to a device 104 and need not be within the device 104.

Second computing device CD 122 can be a mobile device (such as a smartphone) and via a mobile application that can be downloaded on the mobile device, complaint ticket 110 (or its notification can be sent to service person 114.

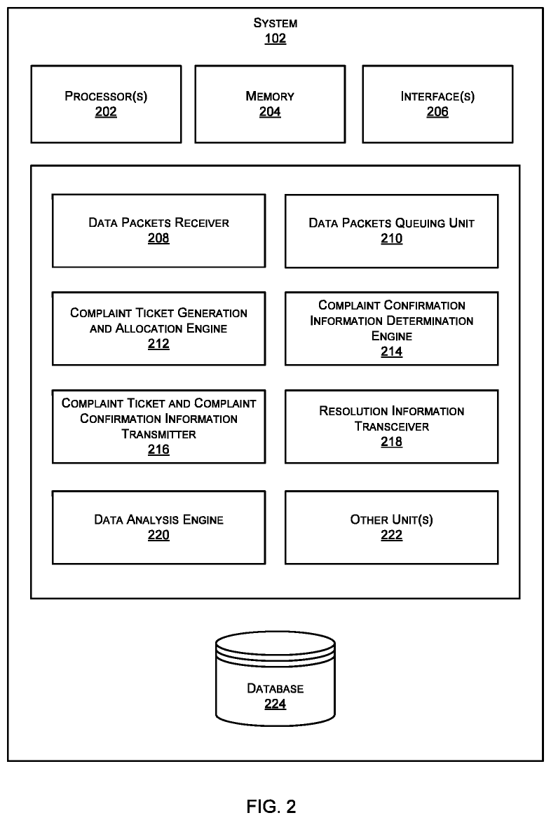

FIG. 2 illustrates functional units of system proposed in accordance with an exemplary embodiment of the present disclosure.

FIG. 2 illustrates various components of a proposed system 102. In an example, the system 102 may be implemented at a first computing device such as a server or in the cloud and communicate with various computing devices as elaborated above using appropriate communication techniques known in the art.

The system 102 may include one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the system 102. The memory 204 may store one or more computer-readable instructions or routines, which may be fetched and executed to create or share the data units over a network service. The memory 204 may include any non-transitory storage device including, for example, volatile memory such as RAM, or non-volatile memory such as EPROM, flash memory, and the like.

The system 102 may also include an interface(s) 206. The interface(s) 206 may include a variety of interfaces, for example, interfaces for data input and output devices, referred to as I/O devices, storage devices, and the like. The interface(s) 206 may facilitate communication of the system 102 with various devices coupled to the system 102. The interface(s) 206 may also provide a communication pathway for one or more components of the system 102.

In an exemplary embodiment, proposed system 102 may include a data packets receiver 208, a data packets queuing unit 210, a complaint ticket generation and allocation engine 212, a complaint confirmation information determination engine 214, a complaint ticket and complaint confirmation information transmitter 216, a resolution information transceiver 218, a data analysis engine 220, other units 222 and database 224.

Various engines and components as mentioned above elaborated further may be implemented as a combination of hardware and programming (for example, programmable instructions) to implement one or more of their functionalities themselves or use processors 202. In examples described herein, such combinations of hardware and programming may be implemented in several different ways. For example, the programming for the engine 212 may be processor executable instructions stored on a non-transitory machine-readable storage medium and the hardware for the engine 212 may include a processing resource (for example, one or more processors), to execute such instructions. In the present examples, the machine-readable storage medium may store instructions that, when executed by the processing resource, implement the various components and engines. In such examples, the system 102 may include the machine-readable storage medium storing the instructions and the processing resource to execute the instructions, or the machine-readable storage medium may be separate but accessible to system 102 and the processing resource. In other examples, the components and engines (such as engine 212) may be implemented by electronic circuitry.

The database 224 may include data that is either stored or generated as a result of functionalities implemented by any of the components of the proposed system 102.

In an aspect, the data packet receiver 208 can control the one or more processors 202 to receive, in response to an input provided by a user (for instance user 112) on an Internet of Things (IoT) device (for instance device 104-1), a first data packet pertaining to a complaint using a message queuing protocol, wherein the message queuing protocol can maintain a queue of plurality of data packets such that the first data packet can be selected from the plurality of data packets. The message queuing protocol can be implemented using data packets queuing unit 210 further described.

In an exemplary embodiment being described herein, user inputs can be provided using pushbuttons 106 on IoT device 104, as already elaborated.

In another aspect, data packet receiver 208 can receive the first data packet (and other data packets) using any or a combination of SMS, E-mail audio and video.

In an exemplary embodiment, the data packet receiver 208 can be any device, such as a receiver with circuitry for receiving data from a device.

In an aspect, data packets queuing unit 210 can control the one or more processors 202 to implement a message queuing protocol to maintain a queue of plurality of data packets such that the first data packet is selected from the plurality of data packets. Such plurality of data packets can be generated by one or more IoT devices (such as device 104-1) according to user inputs being provided therein.

In another aspect, the message queuing protocol implemented by data packets queuing unit 210 can enable queuing of the plurality of data packets indicating corresponding complaints at any or a combination of one or more of the IoT devices and the first computing device.

Further, data packets queuing unit 210 can select the first data packet from the plurality of data packets based on any or a combination of an order in which the plurality of data packets are received at the first computing device and an order in which the plurality of data packets are generated at the one or more of the IoT devices.

As already elaborated, such queuing can happen due various reasons. Further, the message queuing protocol can enable queuing of messages at the IoT devices as well as the proposed system. For instance, an IoT device can store various messages (data packets) when there is no communication between itself and the first computing device, and can transmit all such stored data packets (messages) when communication resumes. Appropriate data queuing unit can be configured in the IoT devices as well for the purpose.

In an aspect, data packets queuing unit 210 can forward the first data packet (and other data packets) according to message queuing protocol to complaint ticket generation and allocation engine 212 further described.

As said, such data queuing units can as well be configured in each of IoT devices 104 as well, and can enable each IoT device 104 as well to queue various data packets as and when required. For instance there could be a situation of no communication between one (or more) IoT device 104 and proposed system 102 due to some network problem. In such a situation, an IoT device 104 can store a plurality of data packets (that can pertain to various complaints being registered by a user using the IoT device, for instance) using its queuing unit. Once communication is restored, queuing unit of the IoT device 104 can forward the various data packets stored according to the message queuing protocol being implemented to the proposed system 102 so that engine 212 can generate complaint tickets accordingly.

In an exemplary embodiment, data packets queuing unit 210 can be one or more processors dedicatedly used to perform functionalities of unit 210 as elaborated above.

In another aspect, the complaint ticket generation and allocation engine 212 can control the one or more processors 202 to generate, based upon the first data packet, a complaint ticket carrying at least a unique identifier associated with the complaint and allocate the complaint to an appropriate service person. Engine 212 can as well provide in the complaint ticket a small description of the complaint.

In an exemplary embodiment, complaint ticket generation and allocation engine 212 can be one or more processors dedicatedly used to perform functionalities of engine 212 as elaborated above.

In another aspect, the complaint confirmation information determination engine 214 can control the one or more processors 202 to determine a complaint confirmation information comprising any or a combination of description of the complaint, unique identifier of the complaint ticket, details of the service person assigned to the complaint and expected time of resolution of the complaint. This determination can be done as soon as engine 212 has generated and allocated a complaint ticket as described above.

In an exemplary embodiment, complaint confirmation information determination engine 214 can be one or more processors dedicatedly used to perform functionalities of engine 212 as elaborated above.

In yet another aspect, the complaint ticket and complaint confirmation information transmitter 216 can control the one or more processors 202 to transmit the complaint ticket to a computing device of the service person, and transmit the complaint confirmation information to the IoT device for display thereupon.

In an exemplary embodiment, the complaint ticket and complaint confirmation information transmitter 216 can be any device such as a transmitter for transmitting data to a device.

In yet another aspect, the resolution information transceiver 218 can control the one or more processors 202 to receive, from the second computing device, a complaint resolution information indicating resolution of the complaint or part thereof by the service person, and can transmit the complaint resolution information or part thereof to the IoT device for display thereupon. Complaint resolution information can be provided by the service person as appropriate.

In an exemplary embodiment, the resolution information transceiver 218 can be any device, such as a transceiver, having both a transmitter and a receiver that are combined and share common circuitry or a single housing for receiving and/or data from/to a device.

In an aspect, database 224 can store all information received and generated by the proposed system 102. The data analysis engine 220 in proposed system 102 can enable its administrator to analyze all such information to generate useful reports such as maintenance history of various machines, performance of various service persons etc. etc. As can be readily understood, all such information can be very useful.

In an exemplary embodiment, data analysis engine 220 can be one or more processors dedicatedly used to perform functionalities of engine 220 as elaborated above.

In an aspect, the other units 222 may implement functionalities that supplement applications or functions performed by the system 102 or its components/engines as being described herein.

It would be appreciated that units and components described above are only exemplary units and any other unit or sub-unit can be included as part of the proposed system. These units too can be merged or divided into super-units or sub-units as may be configured and can be spread across one or more computing devices operatively connected to each other using appropriate communication technologies.

Further, although the proposed system has been elaborated as above to include all the main components/units, it is completely possible that actual implementations may include only a part of the proposed units or a combination of those or a division of those into sub-units in various combinations across multiple devices that can be operatively coupled with each other, including in the cloud. Further the units can be configured in any sequence to achieve objectives elaborated. Also, it can be appreciated that proposed system can be configured in a computing device or across a plurality of computing devices operatively connected with each other, wherein the computing devices can be any of a computer, a laptop, a smart phone, an Internet enabled mobile device and the like. Therefore, all possible modifications, implementations and embodiments of where and how the proposed system is configured are well within the scope of the present invention.

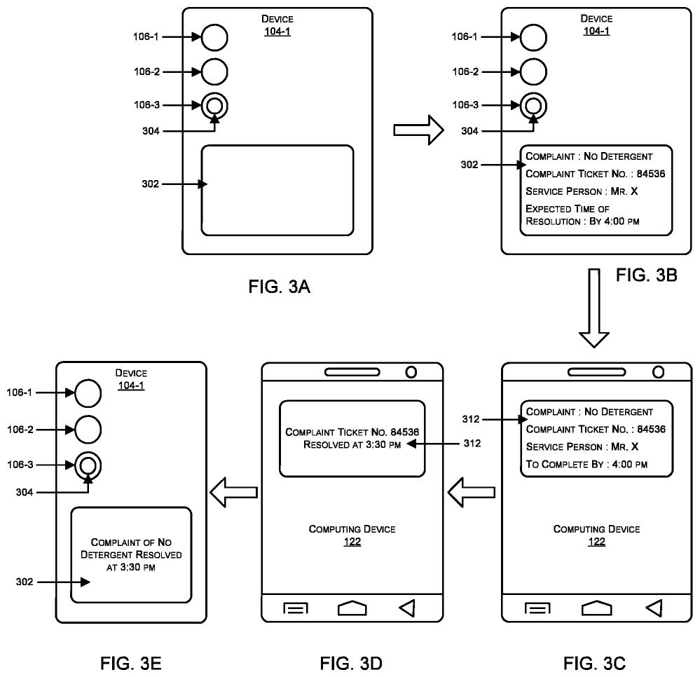

FIGS. 3A to 3E illustrate working of the proposed system in accordance with an exemplary embodiment of the present disclosure.

In an exemplary embodiment, proposed system can be configured to serve a laundry room that can have one/more laundry machines. The laundry room in turn can be situated in an apartment complex. Various residents (users) of the apartment complex can use the laundry machines. The machines may be coin-operated, thereby also offering an additional revenue generation stream for the organization owning/maintaining the apartment complex.

There may be a situation when one/more of the laundry machines may suffer breakdown and become non-operational. In a worse situation, a laundry machine may take coins from a user but not operate at all, or not operate as expected.

Situations as above can lead to revenue loss since different apartment owners upon finding a laundry machine non-functional may simply use another at some other premises. Even otherwise, this can lead to lot of dissatisfaction amongst the users, particularly for those who may have inserted coin into a laundry machine but have neither got a refund nor expected performance from the laundry machine.

There could be other problems. For instance, there could be water stoppage/leakages, supply of detergent may get over etc. In all these cases, typically the customer/user has to reach out to the management to resolve the situation. As elaborated, this may take quite a lot of time, during which time there could be revenue loss as well as increasing dissatisfaction amongst users.

Using system as elaborated, a user need only press a button for corresponding issue to be notified to apartment management/concerned service personnel as appropriate. Further actions can as well be taken, as elaborated via FIG. 3A to FIG. 3E.

As shown in FIG. 3A, device 104-1 (an IoT device) can be configured in the laundry room. Each button of device 104 can be labelled with its associated service/complaint request. For instance, 106-1 can be labelled ‘washer not working’, 106-2 can be labelled ‘dryer not working’, 106-3 can be labelled ‘no detergent in washing machine’ etc. etc. It can be readily understood that device 104 can have as many buttons as required.

In an exemplary embodiment, user 112 (FIG. 1), upon finding no detergent in the washing machine, can press button 106-3. An LED 304 (that may be configured within button 106-3) may switch on to indicate initiation of a complaint.

As elaborated in FIG. 1, a complaint ticket 110 may accordingly be generated and sent to CD 122 of service person 114. Thereafter system 102 can generate and send to device 104-1 a complaint confirmation information 116.

Complaint confirmation information 116 can carry relevant particulars such as complaint, complaint ticket number, service person assigned to the complaint (and the service person's contact phone number) and expected time of resolution etc., and can be displayed at display 302 of device 104-1, as shown in FIG. 3B.

As can be appreciated, user 112 can read information displayed at screen 302 and can thereby know when the machine will be operational and can plan accordingly.

In an exemplary embodiment, each complaint made as above can be displayed on display 302/an alternate display operatively configured with the proposed system so that status of all machines in the laundry room is available at a glance to all users whenever they come to the laundry room.

FIGS. 3C and 3D illustrate processes as can happen on computing device 122 of service person 114. As already elaborated, CD 122 can be a smartphone upon which a mobile application pertaining to proposed system 102 can be downloaded.

Upon a complaint being made as elaborated above, complaint ticket 110 can be generated by proposed system and sent to CD 122. Complaint Ticket 110 can carry relevant particulars for service person 114 and can be displayed at display 312 of CD 122, as shown at FIG. 3C.

Upon service person 114 resolving the complaint, he can provide pertinent information using CD 122 as illustrated at FIG. 3D. The information can be sent as complaint resolution information 118 to proposed system 102 that can forward at least a part of complaint resolution information 118 as resolution information 122 to device 104-1. As shown in FIG. 3E, resolution information 122 can be displayed at display 302 of device 104-1.

In an exemplary embodiment, resolution information 122 can as well be used to trigger a signal to switch off LED 304 in pushbutton 106-3, thereby visually indicating that the complaint has been resolved.

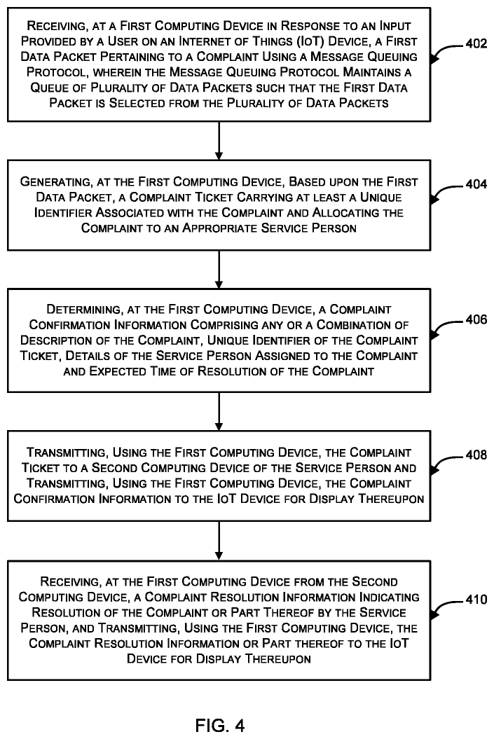

FIG. 4 illustrates a method of implementing system proposed in accordance with an exemplary embodiment of the present disclosure.

In an aspect, method of complaints management proposed can include, at step 402, receiving, at a first computing device in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets.

The method can further include, at step 404, generating, at the first computing device, based upon the first data packet, a complaint ticket carrying at least a unique identifier associated with the complaint and allocating the complaint to an appropriate service person; and at step 406, determining, at the first computing device, a complaint confirmation information comprising any or a combination of description of the complaint, unique identifier of the complaint ticket, details of the service person assigned to the complaint and expected time of resolution of the complaint.

At step 408 the method can include transmitting, using the first computing device, the complaint ticket to a second computing device of the service person and transmitting, using the first computing device, the complaint confirmation information to the IoT device for display thereupon.

At step 410 the method can include receiving, at the first computing device from the second computing device, a complaint resolution information indicating resolution of the complaint or part thereof by the service person, and transmitting, using the first computing device, the complaint resolution information or part thereof to the IoT device for display thereupon.

In an aspect, the proposed method can be described in general context of computer executable instructions. Generally, computer executable instructions can include routines, programs, objects, components, data structures, procedures, modules, functions, etc., that perform particular functions or implement particular abstract data types. The method can also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described herein, the method may be considered to be implemented in the above described system.

As can be readily appreciated, proposed system has many benefits for its users as well. For instance, in an apartment complex having a laundry room as above, if a laundry machine suffers a breakdown, any of its users can immediately raise a service request by simply pressing a button and the service request can as well be instantly passed onto concerned service personnel. This can eliminate outages during production hours, thereby increasing productivity/revenue for the apartment complex management. Besides, residents of the apartment complex can have increased satisfaction since downtime of various equipment will be much lesser. Likewise, it can be used by a janitorial contracting companies to see that various cleaning related complaints are promptly addressed.

Proposed system can help improve maintenance related performance of any industry, particularly of multi-dwelling units and ultimately help to increase profits and satisfaction of users of such services (for instance, occupants of the dwelling units).

The proposed system replaces present paper based systems or those that require calling designated phone numbers and significantly reduces the response time of a service personnel to a complaint relevant to him, thereby improving overall performance and satisfaction levels. to him

Proposed system can find use across a broad spectrum of situations in order to efficiently manage complaints arising from equipment therein. For instance, proposed system may be used in corporate and public restrooms, resorts, pantry rooms, hotels, coffee machine/pantry rooms, publicly accessible areas etc.

As can be readily understood, proposed system can readily be adapted to service related requests as well. For instance, proposed system can be readily deployed in a for requesting laundry service in a hotel room, lunch from in-house restaurant to be brought into a guest's room, various housekeeping related services etc. etc. All such embodiments are fully a part of the present disclosure.

As used herein, and unless the context dictates otherwise, the term “coupled to” is intended to include both direct coupling (in which two elements that are coupled to each other or in contact with each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### ADVANTAGES OF THE PRESENT DISCLOSURE

The present disclosure provides for a complaints management system that enables an equipment maintenance complaint to be lodged immediately.

The present disclosure provides for a complaints management system that enables an equipment maintenance complaint to be transferred without any time loss from its initiation to concerned service personnel for timely resolution.

The present disclosure provides for a complaints management system that monitors an equipment maintenance complaint from its initiation to its resolution.

It is another object of the present disclosure to provide for a complaints management system that reduces downtime, improves productivity of machines and thereby reduces operational cost and increases profit, while at the same time increasing satisfaction of users.

1. A complaints management system (CMS), said system configured in a first computing device and comprising: a data processing system comprising a memory storing processor-executable instructions; and one or more processors configured to execute said processor-executable instructions to:
receive, in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets;
generate, based upon said first data packet, a complaint ticket carrying at least a unique identifier associated with said complaint and allocate said complaint to an appropriate service person;
determine a complaint confirmation information comprising any or a combination of description of said complaint, unique identifier of said complaint ticket, details of said service person assigned to the complaint and expected time of resolution of said complaint;
transmit said complaint ticket to a second computing device of said service person and transmit said complaint confirmation information to said IoT device for display thereupon; and
receive from said second computing device a complaint resolution information indicating resolution of said complaint or part thereof by the service person and transmit said complaint resolution information or part thereof to said IoT device for display thereupon.

2. The system as claimed in claim 1, wherein said message queuing protocol enables queuing of the plurality of data packets indicating corresponding complaints at any or a combination of one or more of said IoT devices and said first computing device.

3. The system as claimed in claim 2, wherein said first data packet is selected from the plurality of data packets based on any or a combination of an order in which said plurality of data packets are received at said first computing device and an order in which said plurality of data packets are generated at said one or more of said IoT devices.

4. The system as claimed in claim 1, wherein the user provides the input by pressing a push button on the IoT device such that a Light Emitting Diode (LED) is switched on, wherein said LED is switched off upon receipt of complaint resolution information.

5. The system as claimed in claim 1, wherein said first computing device is configured at a cloud.

6. The system as claimed in claim 1, wherein said system stores data pertaining to any or a combination of complaint, complaint ticket, complaint confirmation information and complaint resolution information in a database for analysis as needed.

7. The system as claimed in claim 1, wherein said IoT device uses regular electric supply, and automatically switches to an alternate power supply during any disruption in said regular electric supply.

8. The system as claimed in claim 1, wherein said first computing device communicates with said IoT device and said second computing device using any or a combination of Internet, Global System for Mobile Communication (GSM), Wi-Fi, Local Area Network (LAN), Wide Area Network (WAN), Zigbee and Bluetooth.

9. The system as claimed in claim 1, wherein said first data packet, said complaint ticket, said complaint confirmation information and said complaint resolution information are communicated in form of any or a combination of SMS, email, audio and video.

10. The system as claimed in claim 1, wherein at least a part of the system is configured in or operatively coupled to a digital assistant device that receives the first data packet.

11. A method for complaints management, said method comprising:
receiving, at a first computing device in response to an input provided by a user on an Internet of Things (IoT) device, a first data packet pertaining to a complaint using a message queuing protocol, wherein the message queuing protocol maintains a queue of plurality of data packets such that the first data packet is selected from the plurality of data packets;
generating, at said first computing device, based upon said first data packet, a complaint ticket carrying at least a unique identifier associated with said complaint and allocate said complaint to an appropriate service person;
determining, at said first computing device, a complaint confirmation information comprising any or a combination of description of said complaint, unique identifier of said complaint ticket, details of said service person assigned to the complaint and expected time of resolution of said complaint;
transmitting, using said first computing device, said complaint ticket to a second computing device of said service person and transmitting, using said first computing device, said complaint confirmation information to said IoT device for display thereupon;
receiving, at said first computing device from said second computing device, a complaint resolution information indicating resolution of said complaint or part thereof by said service person, and transmitting, using said first computing device, said complaint resolution information or part thereof to said IoT device for display thereupon.

12. The method as claimed in claim 11, wherein said message queuing protocol enables queuing of the plurality of data packets indicating corresponding complaints at any or a combination of one or more of said IoT devices and said first computing device.

13. The method as claimed in claim 12, wherein said first data packet is selected from the plurality of data packets based on any or a combination of an order in which said plurality of data packets are received at said first computing device and an order in which said plurality of data packets are generated at said one or more of said IoT devices.

14. The method as claimed in claim 11, wherein the user provides the input by pressing a push button on the IoT device such that a Light Emitting Diode (LED) is switched on, wherein said LED is switched off upon receipt of complaint resolution information.

15. The method as claimed in claim 11, wherein said first computing device is configured at a cloud.

16. The method as claimed in claim 11, wherein said first computing device is operatively coupled with a database that stores data pertaining to any or a combination of complaint, complaint ticket, complaint confirmation information and complaint resolution information in a database for analysis as needed.

17. The method as claimed in claim 11, wherein said IoT device uses regular electric supply, and automatically switches to an alternate power supply during any disruption in said regular electric supply.

18. The method as claimed in claim 11, wherein said first computing device communicates with said IoT device and said second computing device using any or a combination of Internet, Global System for Mobile Communication (GSM), Wi-Fi, Local Area Network (LAN), Wide Area Network (WAN), Zigbee and Bluetooth.

19. The method as claimed in claim 11, wherein said first data packet, said complaint ticket, said complaint confirmation information and said complaint resolution information are communicated in form of any or a combination of SMS, email, audio and video.

20. The system as claimed in claim 11, wherein at least a part of the system is configured in or operatively coupled to a digital assistant device that receives the first data packet.
